(19) United States
(12) Patent Application Publication
(10) Pub. No.: US 2018/0347734 A1
(43) Pub. Date: Dec. 6, 2018

(54) Connection Assembly for a Fluid System and Method for Producing a Connection Assembly

(71) Applicant: Claude BARATA, Briey (FR)

(72) Inventor: Claude BARATA, Briey (FR)

(73) Assignee: NORMA Germany GmbH, Maintal (DE)

(21) Appl. No.: 15/779,481

(22) PCT Filed: Nov. 15, 2016
(86) PCT No.: PCT/EP2016/077684

§ 371 Date: May 25, 2018

(30) Foreign Application Priority Data
Nov. 26, 2015 (DE) 10 2015 120 508.4

(51) Int. Cl. F16L 25/00; F16L 33/30

(52) U.S. Cl. CPC F16L 25/0045; F16L 33/30

(57) ABSTRACT

The invention relates to a connection assembly (1) for a fluid system, in particular for a coolant system, comprising a line, in particular a coolant line (2), and a connection element (3), wherein the line (2) is designed as a corrugated tube (4) with a corrugated structure (5), wherein the corrugated structure (5) extends up to at least one end (9) of the line (2), wherein the end (8) of the corrugated tube (2) is connected to a connecting piece (11) of the connection element (3), wherein the connecting piece (11) has an outer contour (12) in the shape of a pine tree, onto which the end (8) of the line (2) is pushed on using a plug-in length (10). According to the invention, the corrugated structure (5) on the end of the line is compressed across the push-in length (10). The invention also relates to a method for producing a connection assembly for a fluid system.

The invention relates to a connection arrangement for a fluid system as per the preamble of claim 1, and to a method for producing a connection arrangement for a fluid system, as claimed in claim 9.

Connection arrangements for a fluid system such as a coolant system, for example in a motor vehicle, are suitable for the connection of a (coolant) line to a container or to a further line. For this purpose, a corrugated tube having a corrugated structure is often used since said corrugated structure allows bending of the coolant line, and thus facilitates routing of the line. The patent DE 43 21 575 C1 describes a corrugated tube for use as a fluid line in motor vehicles. The end sections of the presented corrugated tube have smooth ends without corrugations. This serves for the connection to another component because the smooth ends can be pushed onto a connecting element, and fixed, relatively easily. According to current opinion, said smooth ends are provided in order to be able to ensure the required tightness even when pressure and temperature fluctuations occur.

A disadvantage here is that different corrugated tube lengths are required depending on the area of application and arrangement of the components to be connected. As a result of these differing length requirements, it is necessary for corrugated tubes having a wide variety of lengths and in each case smooth ends to be produced and stocked. Additionally, it has to be ensured that the lines, which are in particular in the form of coolant lines, and connection arrangements ensure their function and tightness even in the case of positive pressure and temperature fluctuations.

It is therefore the object of the invention to eliminate the existing prior-art disadvantages and to provide a connection arrangement having a corrugated tube as a line, for example as a coolant line, and having a connecting element, wherein different (coolant) line lengths are able to be produced with little effort. In addition, it is sought to provide a method for producing such a connection arrangement. Said connection arrangement should in this case be cost-effective to produce and easy to assemble.

The main features of the invention are specified in the characterizing part of claim 1, and in claim 9. Advantageous configurations are the subject matter of claims 2 to 8 and 10.

In the case of a connection arrangement for a fluid system, in particular for a coolant system, having a line, in particular a coolant line, and having a connecting element, wherein the line is in the form of a corrugated tube having a corrugated structure, and the corrugated structure extends as far as at least one end of the line, and the end of the corrugated tube is connected to a connecting piece of the connecting element, wherein the connecting piece has a fir tree-like outer contour onto which the end of the line is pushed by way of a plug-on length, the invention provides that the corrugated structure is compressed over the plug-on length at the end of the line.

The connection arrangement according to the invention makes it possible for a corrugated tube with a corrugated end to be connected to a connecting element. This design allows the tube length of the corrugated tube to be shortened to the desired dimension and the line to be adapted to the spatial conditions of the respective fluid system. A smooth end of the corrugated tube, or some other special connecting piece for connection, are no longer necessary. It has surprisingly proven to be the case that, as a result of the compression of that end of the line which is pushed onto the connecting piece, not only high tightness of the connection is achieved but also large pulling-off forces and bursting pressures can be withstood.

For the connection arrangement according to the invention, it is not necessary for different lines with different lengths to be produced and stocked, and this reduces the production and storage costs. During the assembly of the lines, it is possible to deal with and react to the spatial conditions on site in a flexible manner. Moreover, it is easy for the provided connection arrangement to be assembled without the use of a special tool.

The connection arrangement of the design according to the invention is fluid-tight and is able to withstand even elevated pressures which can arise in some cases, in particular in coolant lines, owing to temperature fluctuations.

In the solution according to the invention, the line is advantageously retained against the connecting piece in a force-fitting and frictionally engaging manner with an inner side under radial prestress. Owing to this, apart from the fir tree-like outer contour, no further fastening elements are provided.

The compression of the corrugated structure allows adjacent corrugation peaks of the corrugated structure of the line to bear at least partially against one another over the plug-on length. Said compression has the effect that the inner side of the corrugated tube presses against the fir tree-like outer contour of the connecting piece with greater intensity and the radially inwardly directed force of the corrugated structure is increased, which promotes the tightness and stability of the connection arrangement.

In a preferred configuration, the connecting element is formed in one piece, as a result of which the production and the assembly of the connection arrangement is simplified, and the costs are reduced.

For the formation of a fluid-tight connection arrangement of a fluid system, such as in particular a coolant system, it is preferable for the fir tree-like outer contour of the connecting piece to have an outer diameter which corresponds to at least a minimum inner diameter of the non-compressed line. This ensures that the function of the connection arrangement is maintained, and sufficient radial prestressing forces are generated, even in the case of relatively low compression of the corrugated tube.

In a preferred configuration, the fir tree-like outer contour of the connecting piece has at least one annular elevation which projects in the radial direction and which is formed by a run-on surface and a retaining edge. The run-on surface and the retaining edge are joined to one another, with the run-on surface and the retaining edge being arranged at an angle of 10° to 90° to one another.

This configuration allows the corrugated tube to be pushed onto the connecting piece, with the run-on surface presenting the least possible resistance in the pushing-on direction. As soon as a corrugation trough has overcome the elevation of the fir tree-like outer contour of the connecting piece, the retaining edge prevents the line from sliding back. On the basis of the compression described, after the line is pushed onto the connecting piece, the inner contour of the corrugated tube is pressed against the fir tree-like outer contour of the connecting piece, this resulting in the forces which act to oppose pulling-off being increased further. It is thus possible for the connection arrangement to withstand even greater inner pressures inside the fluid system.

In one development, the fir tree-like outer contour has a plurality of annular elevations, as a result of which the retaining effect described previously is further intensified.

According to a preferred configuration, the line has a corrugated outer contour and inner contour parallel thereto, which are formed as far as the at least one end of the line. The use of a line which is corrugated on the inside and outside allows good flexibility to be achieved, as a result of which the line can be installed relatively easily in, for example, a motor vehicle. A corrugated inner contour also ensures a sufficient retaining force of the fir tree-like outer contour of the connecting piece with respect to the line.

In a preferred embodiment, the line comprises a polyamide. In an alternative variant, the line comprises rubber. Both materials are well suited for forming a fluid-tight line. Here, the material which has the more appropriate chemical and physical properties depending on the necessary requirements may be selected.

In a preferred embodiment, the line has an inner diameter of 10 to 30 mm, in particular of 10 to 15 mm. At this diameter, a sufficient supply and discharge of fluid such as for example cooling liquid can be ensured.

In favored embodiments, the connecting element has, on the side which is averted from the connecting piece with the fir tree-like outer contour, a further connecting structure for fastening the connection arrangement to a container, tank or another tube. In this case, said further connecting element may be provided for example as a plug connector or screw connector. Alternatively, the connecting element may also be fixedly connected to a container or the like.

In addition, the solution according to the invention relates to a method for producing a connection arrangement of a fluid system such as a coolant system. Here, the line or coolant line is cropped to a desired length, and the end of the line is pushed onto the fir tree-like outer contour of the connecting piece such that the corrugated structure of the coolant line is compressed over the plug-on length.

This method allows a connection arrangement of the above-described type to be produced. The line, which is in the form of a corrugated tube having a corrugated structure, may be shortened to the required and desired length before it is connected to the connecting element. The cropping of the line to the corresponding length may be easily carried out already prior to delivery or directly during the on-site assembly. This is possible since special connecting ends, for example in the forms of smooth ends, are no longer necessary. After the corrugated tube is pushed onto the connecting piece of the connecting element, the inner contour of the corrugated tube bears partially against the outer contour of the connecting piece. As a result of the compression, the inner contour of the corrugated tube is pressed on further and radially inwardly directed forces are generated over the plug-on length, which forces are exerted on the connecting piece. Said forces promote tightness and counteract pulling-off of the line. As a result of these effects, a fluid-tight, lasting connection arrangement is obtained, in which, surprisingly, further fastening elements between the line and the connecting piece are no longer necessary.

It is additionally possible by way of this method for a connection arrangement which is able to withstand even elevated pressures to be produced. The normal operating pressure of a line such as a coolant line can thus be 2.5 bar and higher without any problems. The connection arrangement is also temperature-resistant, this likewise being necessary for ensuring the function of the connection arrangement during the operation of the fluid system such as a coolant system.

The compression of the corrugated tube when being pushed onto the connecting piece results in the length of the corrugated tube being shorted in relation to a non-connected state. Here, it is preferable for the compression to shorten the line by 25 to 50% over the plug-on length.

A compression which leads to a shortening in this percentage range generates sufficiently large radially inwardly directed forces which act to oppose pulling-off, with the result that permanent, reliable operation of the fluid system can be ensured by way of a connection arrangement produced in this way.

Further features, details and advantages of the invention will emerge from the wording of the claims and from the following description of exemplary embodiments on the basis of the drawings

In the drawings:

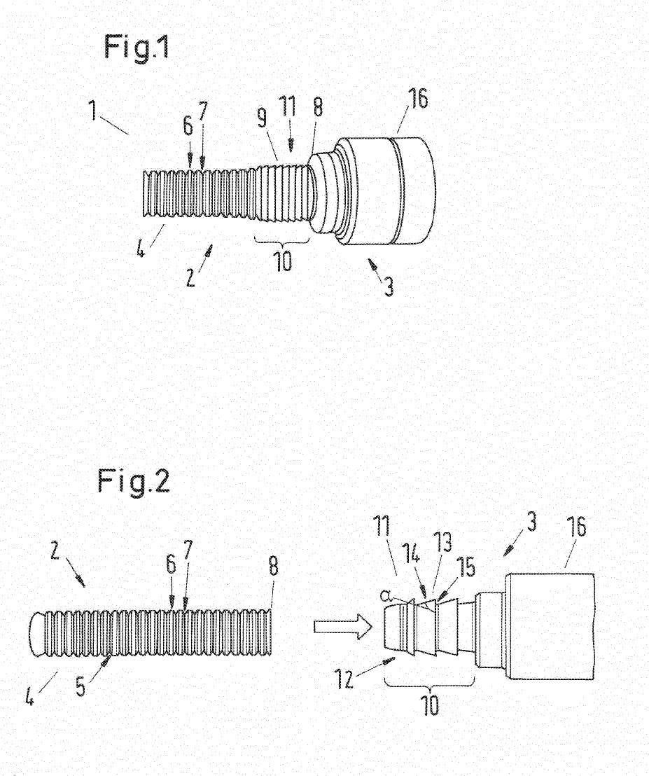

FIG. 1 shows a connection arrangement according to the invention,

FIG. 2 shows components of a connection arrangement.

FIG. 1 shows a connection arrangement 1 according to the invention for a fluid system, in the form of a coolant system, for example of a motor vehicle. The two components of the connection arrangement 1—a line 2 as a coolant line, and a connecting element 3—are shown in FIG. 2. The coolant line 2 is in the form of a corrugated tube 4 having a corrugated structure 5, wherein the corrugated structure 5 can be divided into corrugation peaks 6 and corrugation troughs 7. The corrugated tube 4 may be in the form of a corrugated tube 4 having a parallel-type corrugated structure 5, as illustrated in FIG. 1, or else having a spiral-shaped corrugated structure. This second type of corrugated tube 4 is not illustrated in the figures. The corrugated structure 5 extends as far as at least one end 8 of the coolant line 2. Since no smooth end piece or other special connecting structure is required at the corrugated-tube end 8, adaptation of the length of the coolant line 2 to the required length is possible without any problems. The corrugated tube 4 may be cropped for example, it being necessary to take into account a loss of length owing to a compression 9 (FIG. 1) of the corrugated structure 5 over the plug-on length 10 at the end 8 of the corrugated tube 4.

The connecting element 3 has a connecting piece 11 with a fir tree-like outer contour 12 onto which the end 8 of the coolant line 2 is pushed by way of the plug-on length 10. The fir tree-like outer contour 12 of the connecting piece 11 is formed by at least one annular elevation 13 which projects in the radial direction and which has a run-on surface 14 and a retaining edge 14 which are joined at an angle α. The run-on surface 15 serves the purpose of the coolant line 2 experiencing only a low resistance when being pushed onto the connecting piece 11. If the corrugated tube 4 has then been pushed onto the connecting piece 11, the retaining edge 14 prevents the line 2 from sliding back. The fir tree-like outer contour 12 optionally comprises a plurality of elevations 13.

In addition to the connecting piece 11, it is possible to provide on the connecting element 3 yet a further connecting structure 16 which allows a connection of the connection arrangement 1 to a container, tank or another tube. Furthermore, the entire connecting element 3 is formed with an inner hollow space which is open in the axial direction and which allows a fluid throughflow. The connection arrangement 1 is able to be used not only for coolants but also for other fluids.

The coolant line 2, or rather the corrugated tube 4, is plugged directly onto the connecting piece 11 with the fir tree-like outer contour 12. The fitting can thus be carried out very easily, quickly and without any special tool.

In FIG. 1, the compression 9 of the corrugated structure 5 of the coolant line 2 over the plug-on length 10 can be seen. As a result of the compression 9, adjacent corrugation peaks 6 bear at least partially against one another over the plug-on length 10. The compression 9 has the effect that the inner contour of the corrugated tube 2 is pressed on the fir tree-like outer contour 12 of the connecting piece 11. Consequently, radially inwardly acting forces are generated, which ensure a fluid-tight connection arrangement 1. In addition, as a result of the compression 9, those forces which counteract pulling-off of the corrugated tube 2 are intensified. Consequently, it is also possible for the coolant system to be operated in the case of positive pressure.

The invention is not restricted to one of the above-described embodiments, but may be modified in a variety of ways. It is in particular preferable here for the connection arrangement according to the invention to be used in a fluid system in the form of a coolant system, in which arrangement the line serves as a coolant line. A coolant system having a coolant line thus serves as an exemplary embodiment. Generally, a “fluid system” is to be understood as meaning a system for guiding, and possibly distributing, liquids.

All of the features and advantages which emerge from the claims, from the description and from the drawing, including structural details, spatial arrangements and method steps, may be essential to the invention both individually and in a wide variety of combinations.

### LIST OF REFERENCE SIGNS

1 Connection arrangement
2 (Coolant) line
3 Connecting element
4 Corrugated tube
5 Corrugated structure
6 Corrugation peaks
7 Corrugation troughs
8 End of the coolant line 2
9 Compression
10 Plug-on length
11 Connecting piece
12 Fir tree-like outer contour
13 Elevation
14 Run-on surface
15 Retaining edge
16 Connecting structure
α Angle between run-on surface 15 and retaining edge 16

1. A connection arrangement for a fluid system comprising a line and a connecting element, wherein the line is in the form of a corrugated tube having a corrugated structure, wherein the corrugated structure extends as far as at least one end of the line, wherein the end of the corrugated tube is connected to a connecting piece of the connecting element, wherein the connecting piece has a fir tree-like outer contour onto which the end of the line is pushed by way of a plug-on length, and wherein the corrugated structure is compressed over the plug-on length at the end of the line.

2. The connection arrangement for a fluid system as claimed in claim 1, wherein the line is retained against the connecting piece in a force-fitting and frictionally engaging manner with an inner side under radial prestress.

3. The connection arrangement for a fluid system as claimed in claim 1, wherein adjacent corrugation peaks of the corrugated structure bear at least partially against one another over the plug-on length.

4. The connection arrangement for a fluid system as claimed in claim 1, wherein the fir tree-like outer contour of the connecting piece has an outer diameter which corresponds to at least a minimum inner diameter of the line in a non-compressed state.

5. The connection arrangement for a fluid system as claimed in claim 1, wherein the line has a corrugated outer contour and inner contour parallel thereto, both of which are formed as far as the at least one end of the line.

6. The connection arrangement for a fluid system as claimed in claim 1, wherein the line comprises a polyamide.

7. The connection arrangement for a fluid system as claimed in claim 1, wherein the line comprises a rubber.

8. The connection arrangement for a fluid system as claimed in claim 1, wherein the line has an inner diameter that ranges between approximately 10 millimeters (mm) to 30 mm.

9. A method for producing a connection arrangement as claimed in claim 1, wherein the line is cropped to a desired length, and the end of the line is pushed onto the fir tree-like outer contour of the connecting piece such that the corrugated structure of the line is compressed over the plug-on length.

10. The method for producing a connection arrangement as claimed in claim 9, wherein the compression shortens the line by approximately 25 percent (%) to 50% over the plug-on length.

11. The connection arrangement for a fluid system as claimed in claim 8, wherein the inner diameter of the line ranges between approximately 10 millimeters (mm) to 15 mm.
